(19) United States
(12) Patent Application Publication
(10) Pub. No.: US 2025/0043133 A1
(43) Pub. Date: Feb. 6, 2025

(54) SILOXANE-BASED NON-STICK COATING COMPOSITION INCLUDING A FLUORIDE COMPONENT

(71) Applicant: PPG Industries Ohio, Inc., Cleveland, OH (US)

(72) Inventors: Thomas J. Bate, Glenview, IL (US); Peter Richard Jepson, Exton, PA (US); Manish Kr Mishra, Pittsburgh, PA (US); Vincent S. Pagnotti, Wexford, PA (US); John R. Yetter, Pittsburgh, PA (US); Songwei Lu, Wexford, PA (US)

(73) Assignee: PPG Industries Ohio, Inc., Cleveland, OH (US)

(21) Appl. No.: 18/717,522

(22) PCT Filed: Dec. 8, 2022
(86) PCT No.: PCT/US2022/081180

§ 371 Date: Jun. 7, 2024

Related U.S. Application Data
(60) Provisional application No. 63/287,701, filed on Dec. 9, 2021.

(51) Int. Cl. C09D 5/16; C08K 3/16; C09D 7/61; C09D 183/04

(52) U.S. Cl. CPC C09D 5/1687; C09D 5/1675; C09D 7/61; C09D 183/04; C08K 2003/162

(57) ABSTRACT

Siloxane-based coating compositions that may be applied to the surface of a substrate, such as an article of cookware or bakeware, to form a durable non-stick coating with extended easy to clean properties. The coating compositions may include a siloxane resin, an organic oil, and a fluoride component such as particles of calcium fluoride (CaF₂), magnesium fluoride (MgF₂), strontium fluoride (SrF₂), and/or barium fluoride (BaF₂).

### CROSS-REFERENCE TO RELATED APPLICATIONS

This application claims the benefit under 35 U.S.C. § 119(e) of U.S. Provisional Application No. 63/287,701 filed on Dec. 9, 2021, which is incorporated by reference in its entirety.

### BACKGROUND

### 1. Field of the Disclosure

The present disclosure provides a siloxane or silicone-based, non-stick coating composition that may be applied to an interior, or food-contact, surface and/or to an exterior, or heat-contact, surface of an article of cookware or bakeware. A coating may be formed of the composition to provide a surface having properties and which also is easy to clean for an extended use period.

### 2. Background

Heat resistant non-stick coatings are applied to substrates such as cookware or bakeware to cover the substrate and to provide additional functions such as aiding in heat transfer, providing a non-stick release surface, and/or providing a decorative color or aesthetic finish. Prior coating compositions have either been based on fluoropolymers or have employed non-fluoropolymer base resins but tend to lose their non-stick and easy cleaning characteristics, which may limit their service life.

Non-stick coating compositions based on silicones or siloxanes formed from a silicone based resin may be used as an alternative for fluoropolymers. Siloxane coatings tend to include silicone oils which, upon application of the coating to a substrate followed by curing, tend to migrate to the coating surface to provide a release effect. However, the silicone oils tend to gradually be lost from the coating surface over time and repeated use of the cookware substrate, which first causes deterioration of the release characteristics of the coating even though the substrate and its coating are still useable and easy to clean after use. However, further use of the substrate and deterioration of the coating eventually reaches the point where the substrate and its coating are not cleanable, with food reside remaining on the coating after use which becomes increasingly difficult to fully remove via cleaning.

Improvements in the foregoing are desired.

### SUMMARY

The present disclosure provides siloxane-based coating compositions that may be applied to the surface of a substrate, such as an article of cookware or bakeware, to form a durable non-stick coating with extended easy to clean properties. The coating compositions may include a siloxane resin, an organic oil, and a fluoride component such as particles of calcium fluoride (CaF₂), magnesium fluoride (MgF₂), strontium fluoride (SrF₂), and/or barium fluoride (BaF₂).

In one form thereof, the present disclosure provides a siloxane-based coating composition in liquid form, including a siloxane resin, a fluoride component selected from calcium fluoride (CaF₂), magnesium fluoride (MgF₂), strontium fluoride (SrF₂), barium fluoride (BaF₂), and combinations of the foregoing, present in an amount from 5 wt. % to 50 wt. %, based on a total weight of the coating composition, and a solvent.

In another form thereof, the present disclosure provides a coated article, including a substrate having a surface and a coating disposed on the surface, including a siloxane resin, a fluoride component selected from calcium fluoride (CaF₂), magnesium fluoride (MgF₂), strontium fluoride (SrF₂), barium fluoride (BaF₂), and combinations of the foregoing, present in an amount from 10 wt. % to 60 wt. %, based on the total weight of the coating.

### BRIEF DESCRIPTION OF THE DRAWINGS

The above mentioned and other features of the disclosure, and the manner of attaining them, will become more apparent and the disclosure itself will be better understood by reference to the following description of aspects of the disclosure taken in conjunction with the accompanying drawings.

FIG. 1 shows thermal conductivity of silicone polyester free-films comprised of different fillers at 40% solids in dry film.

FIG. 2 shows thermal conductivity of silicone polyester at different loading of CaF₂.

FIG. 3 shows the Tg of coatings measured using DSC technique where coating contains CaF₂ at 40 wt. % on dry film basis.

FIG. 4 shows the glass transition temperature of nonstick coating compositions as a function of concentration of added CaF₂

FIG. 5. Shows average cross-link density of the coatings comprised of different inorganic fillers.

### DETAILED DESCRIPTION

### I. Introduction

The present disclosure provides a silicone- or siloxane-based coating composition and resulting coating comprising a silicone base resin, an organic oil, a fluoride component, a solvent. The coating composition and resulting coating may further comprise one or more reinforcing fillers. The solvent may comprise an organic solvent or alternatively, the solvent may comprise water. The coating composition may be applied to a substrate as a single layer coating, or the coating composition may be applied to a substrate as a component layer of a multilayer coating comprising, for example, a basecoat, optionally one or more inter-coats, and a topcoat.

The coating composition and resulting coating may lack fluoropolymer components used in prior non-stick coating compositions. The components of the coating compositions are described in further detail below.

### II. Definitions

For purposes of the following detailed description, it is to be understood that the disclosure may assume various alternative variations and step sequences, except where expressly specified to the contrary. Moreover, other than in any operating examples or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

As used herein, the term “a” means at least one, i.e., one or more.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

The use of the singular includes the plural and plural encompasses singular, unless specifically stated otherwise. In addition, the use of “or” means “and/or” unless specifically stated otherwise, even though “and/or” may be explicitly used in certain instances.

The use of the term “non-stick” herein is intended to mean a coating having release properties, particularly when the coating is applied to articles of cookware and/or bakeware. When the coating is applied to articles of cookware and/or bakeware, non-stick may pertain to food release properties, including food fouling release properties.

The use of the term “easy clean” or “easy to clean” refers to a coating characteristic wherein food residue may be readily removed from the surface of the coating, such as after cooking.

As used herein, the term “siloxane” refers to Si—O—Si based linkages and/or polymers including such linkage, which term also includes silicone (Si—O) based linkages and/or polymers including such linkages.

### III. Substrates

The coating composition may be applied to the surface of a substrate. Suitable substrates may include metals, ceramic materials, plastics, and composites. Suitable metals may include stainless steel, aluminum, and carbon steel, for example. Suitable ceramic materials include glasses like borosilicate glass, porcelain enamels, various fired clays and other refractory materials, for example. Suitable plastics and composites include high melting point plastics and composites, such as plastics having a melting point higher than the cure temperature of the coating formulation, including polyester, polypropylene, ABS, polyethylene, carbon fiber epoxy composites, and glass fiber epoxy composites, for example.

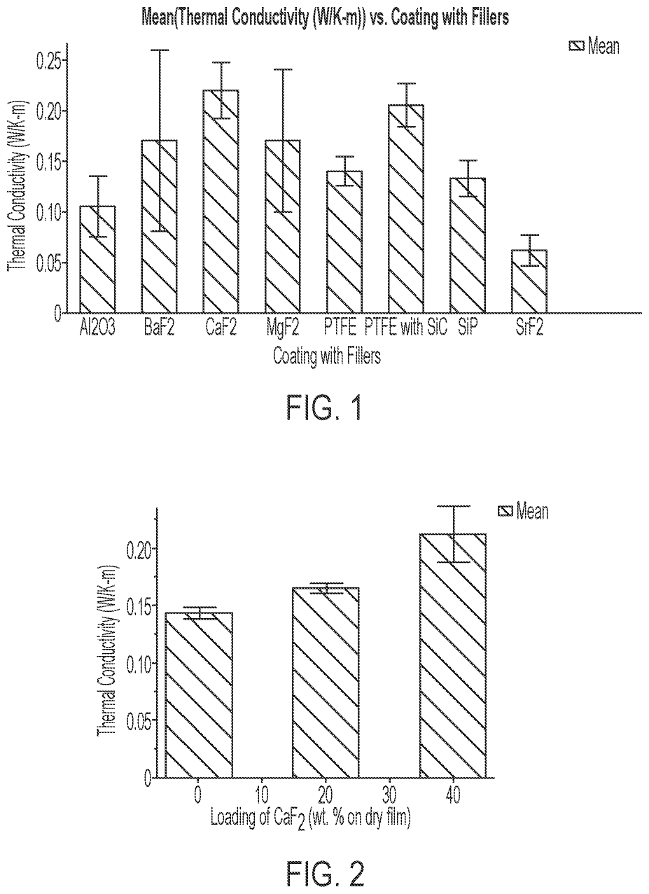

The substrate may be a portion of a pan or other article of cookware. Referring to FIG. 1, an article of cookware 10 is shown in the form of a pan, which generally includes a circular bottom wall 12, an annular side wall 14, and a handle 16. Cookware article 10 is typically a metal or metal alloy such as stainless steel, aluminum, and carbon steel, but may also be a ceramic material, a plastic or a composite, for example.

Bottom and side walls 12 and 14 include an interior or food contact surface 18 facing the food to be cooked, as well as an opposite, exterior or heat contact surface 20 which, in use, faces, is adjacent to, or contacts a heat source or heating element 22. As shown in FIG. 1B, article of cookware 10 may include an interior coating 24 over at least a portion of its respective interior surface 18, including at least a portion of, or all of, bottom wall 12 and/or side walls 14.

In this manner, the present coating compositions may be used as either an interior coating or an exterior coating. Although article of cookware 10 is shown as a pan, the present coating compositions may also be used to form coatings for other articles of cookware, such as skillets, griddles, pots and the like, as well as articles of bakeware or other cooking articles which are exposed to heat in use.

The present coating compositions may also be used to coat non-cookware articles, such as rollers, molds, conduits and fasteners, which require a non-stick or release property and/or which are exposed to heat in use.

### IV. Coating Compositions

It is desirable for coating compositions used for cookware and bakeware to possess both non-stick features and resistance to abrasion. In the past, per- and poly-fluoroalkyl substances (PFAS) have been used in this capacity. However, demand has arisen for PFAS-free coatings. Silicone-based compositions may be used to form non-stick coatings instead of PFAS-containing compositions. The coating compostions of the present disclosure seek to maintain the non-stick properties of compositions that include PFAS while being substatially free of PFAS.

The present disclosure provides a coating composition capable of maintaining easy cleanability even if initial food release properties gradually fail over the useful lifetime of the coating. The coating composition may comprise a single layer. Alternatively, the coating composition may comprise a multi-layer composition including, for example, a basecoat, an optional inter-coat, and a topcoat.

The coating composition may also facilitate heating of the surface of the coated substrate more quickly than traditional non-stick coatings. The coating may comprise a siloxane resin, such as a silicone polyester, a silicone epoxy, a silicone phenoxy, a silicone polyurethane, or combinations thereof, for example.

The coating may further comprise a fluoride component. The coating may further comprise one or more organic oils including silicone oils, such as a high molecular weight silicone oil, a low molecular weight silicone oil, or a combination thereof. The coating may further comprise one or more reinforcing fillers.

The present coating compositions may be applied directly to the surface of the substrate article or alternatively, may be applied over one or more underlying coatings, or undercoats such as a primer which is applied directly to the outer surface of the substrate article, with the coatings of the present disclosure applied over the primer.

a. Siloxane Resins

The coatings of the composition of the present disclosure may include a siloxane as a base resin or primary film-forming resin. For example, the siloxane resin may be a silicone epoxy, a silicone polyester, silicone phenoxy, silicone polyurethane, and a combination of the foregoing.

The siloxane resin may be formed from organosiloxane-based solid polymers, which are typically thermoset compositions capable of providing a range of mechanical characteristics, ranging from soft and rubbery to hard and brittle, and/or organosilane based sol-gel coatings, which are typically based on a hydrolysis and condensation reaction of the silane chemistry as discussed in U.S. Pat. No. 10,544,306. The hardness of the composition is generally proportional to the degree of crosslinking in the composition. The degree of crosslinking may in turn be dependent upon the nature of the organosiloxane unit used in the composition.

As shown in Table 1 below, organosiloxanes may be described according to the degree of oxygen substitution, or functionality, on the central silicone.

TABLE 1

| Structural formula | Functionality | Symbol |
|---|---|---|
| R₃Si—O— | Monofunctional | M |
| 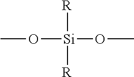 | Difunctional | D |
| 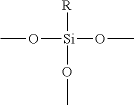 | Trifunctional | T |
| 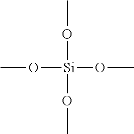 | Tetrafunctional | Q |

Generally, compositions including higher fractions of T (trifunctional) and Q (tetrafunctional) units display higher degrees of crosslinking.

The siloxane resins may be dispersed in a solvent. The resin content in the solvent may be about 40 wt. % or higher, about 50 wt. % or higher, about 60 wt. % or higher, about 65 wt. % or lower, about 70 wt. % or lower, about 75 wt. % or lower, or any value encompassed by these endpoints.

The silicone content of the resins may be about 30 wt. % or greater, about 32 wt. % or greater, about 34 wt. % or greater, about 36 wt. % or greater, about 38 wt. % or greater, about 40 wt. % or lower, about 42 wt. % or lower, about 44 wt. % or lower, about 46 wt. % or lower, about 48 wt. % or lower, about 50 wt. % or lower, or any value encompassed by these endpoints.

The siloxane polymer may be present in the coating composition in an amount of about 30 wt. % or greater, about 40 wt. % or greater, about 50 wt. % or greater, about 60 wt. % or greater, about 65 wt. % or less, about 70 wt. % or less, about 75 wt. % or less, or any value encompassed by these endpoints, as a percentage of the total coating composition weight on a wet weight basis.

The siloxane polymer may be present in the coating composition in an amount of about 40 wt. % or greater, about 50 wt. % or greater, about 60 wt. % or greater, about 70 wt. % or less, about 75 wt. % or less, about 80 wt. % or less, about 85 wt. % or less, about 90 wt. % or less, or any value encompassed by these endpoints, as a percentage of the total coating composition weight on a dry (solids) weight basis.

b. Fluoride component

The coatings of the present disclosure may include a fluoride component, which may be present in particulate form in the coating composition. Such components may include ionic fluorine-containing compounds, such as fluoride salts of group II metals. Suitable such compounds may include calcium fluoride (CaF₂), for example. Suitable such ionic fluorine-containing compounds may also include magnesium fluoride (MgF₂), barium fluoride (BaF₂), or strontium fluoride (SrF₂).

The fluoride component is distinct from reinforcing filler particles which have traditionally been used in non-stick coating compositions, as discussed below. Filler particles are hard particles that assist in providing abrasion resistance, for example, but do not enhance the release and/or easy-cleaning performance of non-stick coatings. These particles are present in relatively small amounts in the coating as described herein. In contrast, the fluoride components of the present coatings form a major constituent of the coating, are distributed throughout the base resin of the coating, and may be present in higher amounts or concentrations toward the surface of the coating, such that a concentration gradient is formed with the fluoride component present at a smaller concentration near the surface of the substate or an underlying layer and present at a larger concentration near the exposed surface of the coating. In this manner, the fluoride component may enhance or prolong the release and easy-cleaning performance of non-stick coatings.

Cleanability may be related to the presence of the fluoride component in the coating wherein, without wishing to be bound by theory, the fluoride component may be surface modified by an organic oil including silicone oil, and permit higher concentrations of silicone oil in the topcoat, with the fluoride component functioning to retain or trap the silicon oil in the coating and delaying the loss of silicone oil from the surface of the coating, thereby prolonging the cleanability of the coated substrate. In this manner, the initial presence of a relatively greater amount of silicone oil in the coating, and relatively greater retention of the silicone oil in the coating, may lead to a longer useable lifetime of the coated article.

One suitable fluoride component is calcium fluoride (CaF₂). It has surprisingly been found that coatings including calcium fluoride (CaF₂) may have improved cleanability characteristics.

The fluoride component may be present in the coating composition in an amount of about 2 wt. % or greater, about 10 wt. % or greater, about 20 wt. % or greater, about 25 wt. % or greater, about 30 wt. % or less, about 35 wt. % or less, about 40 wt. % or less, about 50 wt. % or less or any value encompassed by these endpoints, as a percentage of the total coating composition weight on a wet weight basis.

The fluoride component may be present in the coating composition in an amount of about 5 wt. % or greater, about 15 wt. % or greater, about 25 wt. % or greater, about 35 wt. % or greater, about 45 wt. % or greater, about 50 wt. % or less, about 55 wt. % or less, about 60 wt. % or less, or any value encompassed by these endpoints, as a percentage of the total coating composition weight on a dry (solids) weight basis.

The fluoride component may have an average particle size (D50) of about 5 micrometers or larger, about 10 micrometers or larger, about 15 micrometers or larger, about 20 micrometers or larger, about 25 micrometers or later, about 30 micrometers or larger, about 35 micrometers or larger, about 40 micrometers or larger, about 45 micrometers or larger, about 50 micrometers or larger, 55 micrometers or smaller, 60 micrometers or smaller, 65 micrometers or smaller, 70 micrometers or smaller, 75 micrometers or smaller, 80 micrometers or smaller, 85 micrometers or smaller, 90 micrometers or smaller, 95 micrometers or smaller, 100 micrometers or smaller, or any value encompassed by these endpoints, as determined by dynamic light scattering.

c. Reinforcing Filler

The composition may additionally comprise one or more reinforcing fillers, also referred to simply as fillers. Exemplary reinforcing fillers include silicas, alumina, titania, zirconia, wollastonite, quartz, silicone carbide, christobalite, synthetic diamonds, topas, orthoclase, apatite, and short glass fibers.

The reinforcing fillers may have a Mohs hardness of 4 or higher as determined by ASTM E92-17. Alternatively, the hardness of the reinforcing fillers may be described using Knoop hardness. The reinforcing fillers may have a Knoop hardness of 160 kg/m² or greater as determined by ASTM C1326.

The reinforcing fillers may also be described by their size. The particle size may be determined by dynamic light scattering. Alternatively, the particle size may be determined by scanning electron microscopy (SEM) analysis. A visual examination of a scanning electron microscopy (SEM) micrograph is conducted, in which the diameters of the particles in the image may be measured following magnification of the image as measured in cross section, with no size correction. From these measurements, the average primary particle size may then be calculated. The primary particle size is defined herein as the smallest diameter sphere that will completely enclose the particle. Thus, the primary particle size refers to the size of individual particles rather than agglomerations of two or more particles. To ensure a sufficient representation of possible particle sizes, a sample of 20 particles or more, 50 particles or more, 70 particles or more, or 100 particles or more may be measured.

The reinforcing fillers may have an average particle size (D50) of about 5 micrometers or larger, about 10 micrometers or larger, about 15 micrometers or larger, about 20 micrometers or larger, about 25 micrometers or later, about 30 micrometers or larger, about 35 micrometers or larger, about 40 micrometers or larger, about 45 micrometers or larger, about 50 micrometers or larger, 55 micrometers or smaller, 60 micrometers or smaller, 65 micrometers or smaller, 70 micrometers or smaller, 75 micrometers or smaller, 80 micrometers or smaller, 85 micrometers or smaller, 90 micrometers or smaller, 95 micrometers or smaller, 100 micrometers or smaller, or any value encompassed by these endpoints, as determined by dynamic light scattering.

The reinforcing fillers may have a variety of shapes. For example, the reinforcing fillers may be spherical, oval, or platelet shaped. The reinforcing fillers may also be defined by their size ratio. The size ratio is defined herein as the ratio of the particle size “p” to the thickness of the coating “t”. The size ratio may be determined by cutting a cross section of the coating and polishing it using a lapping technique so that it is observable by scanning electron microscopy (SEM) at a magnification of between 500× and 5000×. Dimensional imaging may be performed by measuring the particle size with the smallest circle circumscribed to the particle and measuring the film thickness of the coating by point-to-point measurements between the observable substrate surface and the coating surface.

The ratio of the thickness of the coating to the particle is about 0.5:1.0 or greater, about 0.6:1.0 or greater, about 0.7:1.0 or greater, about 0.8:1.0 or greater, about 0.9:1.0 or greater, about 1.0:1.0 or greater, about 1.1:1.0 or greater, about 1.2:1.0 or greater, about 1.3:1.0 or less, about 1.4:1.0 or less, about 1.5:1.0 of less, about 1.7:1.0 or less, about 1.8:1.0 or less, about 1.9:1.0 or less, about 2.0:1.0 or less, about 2.1:1.0 or less, about 2.2:1.0 or less, or any value encompassed by these endpoints as determined by scanning electron microscopy cross-section analysis.

The one or more reinforcing fillers may be present in the composition in an amount of about 1 wt. % or greater, 3 wt. % or greater, about 4 wt. % or greater, about 5 wt. % or greater, about 6 wt. % or less, about 7 wt. % or less, about 8 wt. % or less, about 9 wt. % or less, about 10 wt. % or less, or any value encompassed by these endpoints, as a percentage of the total coating composition weight on a wet weight basis.

The one or more reinforcing fillers may be present in the composition in an amount of about 1 wt. % or greater, 5 wt. % or greater, about 10 wt. % or greater, about 15 wt. % or greater, about 20 wt. % or less, about 25 wt. % or less, about 30 wt. %, or any value encompassed by these endpoints, as a percentage of the total coating composition weight on a dry (solids) weight basis.

d. Organic Oils

Organic oils may be used in coating composition in order to improve non-stick and cleanability characteristics. Organic oils may include silicone oils, and/or fatty acids that occur from various animal and vegetable fats and oils, including oleic acid, stearic acid, palmitic acid, erucic acid, linoleic acid, and/or linolenic acid.

The organic oil may be present in the coating solution in an amount of 0.01 wt. % or greater, about 1.0 wt. % or greater, about 2.0 wt. % or greater, about 5.0 wt. % or greater, about 6.0 wt. % or less, about 7.0 wt. % or less, about 8.0 wt. % or less, about 9.0 wt. % or less, about 10.0 wt. % or less, or any value or range encompassed by these endpoints.

The organic oil may comprise silicone oil. Silicone oils may be used in coating compositions in order to improve non-stick and cleanability characteristics. Over time, the silicone oils may be worn or washed away from the coating, thereby limiting the lifespan of the article as its utility is decreased. Attempting to load a larger amount of silicone oil into the coating to prolong the lifetime of the article is generally unsuccessful, however, as excess oil will migrate to the surface and “squeeze out” of the coating.

It has surprisingly been found that the coating compositions of the present disclosure permit larger amounts of silicone oil to be loaded into the coating, with the presence of a larger amount of silicone oil found to prolong the useful lifetime of the coated article.

The present coatings may include one or more silicone oils, such as a medium molecular weight silicone oil, a high molecular weight silicone oil, or combinations thereof.

The medium molecular weight silicone oil may have a number average molecular weight, as derived from kinematic viscosity measurements, for example, of about 12,000 g/mol or greater, about 12,500 g/mol or greater, about 13,000 g/mol or greater, about 13,500 g/mol or less, about 14,000 g/mol or less, about 14,500 g/mol or less, about 15,000 g/mol or less, or any value or range encompassed by these endpoints.

The high molecular weight silicone oil may have a molecular weight of about 90,000 g/mol or greater, about 92,000 g/mol or greater, about 94,000 g/mol or greater, about 96,000 g/mol or less, about 98,000 g/mol or less, about 100,000 g/mol or less, or any value or range encompassed by these endpoints.

The medium molecular weight silicone oil may be present in the coating composition in an amount of about 0.01 wt. % or greater, about 1.0 wt. % or greater, about 2.0 wt. % or greater, about 5.0 wt. % or greater, about 6.0 wt. % or less, about 7.0 wt. % or less, about 8.0 wt. % or less, about 9.0 wt. % or less, about 10.0 wt. % or less, or any value encompassed by these endpoints, based on the total weight of the coating composition on a wet weight basis.

The medium molecular weight silicone oil may be present in the coating composition in an amount of about 0.02 wt. % or greater, about 1.0 wt. % or greater, about 3.0 wt. % or greater, about 6.0 wt. % or greater, about 7.0 wt. % or less, about 8.0 wt. % or less, about 10.0 wt. % or less, about 12.0 wt. % or less, or any value encompassed by these endpoints, based on the total weight of the coating composition on a dry weight basis.

The high molecular weight silicone oil may be present in the coating composition in an amount of about 0.01 wt. % or greater, about 1.0 wt. % or greater, about 2.0 wt. % or greater, about 5.0 wt. % or greater, about 6.0 wt. % or less, about 7.0 wt. % or less, about 8.0 wt. % or less, about 9.0 wt. % or less, about 10.0 wt. % or less, or any value encompassed by these endpoints, based on the total weight of the coating composition on a wet weight basis.

The high molecular weight silicone oil may be present in the coating composition in an amount of about 0.02 wt. % or greater, about 1.0 wt. % or greater, about 3.0 wt. % or greater, about 6.0 wt. % or greater, about 7.0 wt. % or less, about 8.0 wt. % or less, about 10.0 wt. % or less, about 12.0 wt. % or less, or any value encompassed by these endpoints, based on the total weight of the coating composition on a dry weight basis.

e. Pigments

The coatings of the present disclosure may further comprise one or more pigments. Suitable pigments include pigments of biologic origin, synthetic pigments, metal oxides, ochres, or minerals, such as Keystone channel black pigment and Al flake pigment, for example. The pigments may be used as powders or liquids or may be formulated as a paste.

The total amount of pigments may be 0 wt. % or greater, 0.1 wt. % or greater, 0.2 wt. % or greater, 0.3 wt. % or greater, 0.5 wt. % or greater, 1 wt. % or less, 10 wt. % or less, 20 wt. % or less, or 30 wt. % or less, or any value or range encompassed by these endpoints, based on the total weight of the composition on a wet weight basis.

The total amount of pigment(s) may be 0 wt. % or greater, 0.2 wt. % or greater, 0.5 wt. % or greater, 1.5 wt. % or greater, 3 wt. % or less, 5 wt. % or less, 10 wt. % or less, or 15 wt. % or less, or any value or range encompassed by these endpoints, based on the total weight of the composition on a dry weight basis.

f. Additives

The coatings of the present disclosure may further comprise one or more additives such as thickeners, surfactants, thinners, and extenders. Suitable additives may include talc, mica, barium sulfate, associative polyurethane thickeners, alkali-swellable acrylic thickeners, bentone clays, non-ionic surfactants such as alkyl ethoxylates, acetylenic surfactants, siloxane polyether-based surfactants, fatty acid-, silica-, and siloxane-based defoamers, and the like. These additives may be present in the coating in an amount of about 0.1 wt. % or greater, about 1 wt. % or greater, about 5 wt. % or greater, about 10 wt. % or greater, about 20 wt. % or greater, about 30 wt. % or less, about 40 wt. % or less, about 50 wt. % or less, about 60 wt. % or less, or any value encompassed by these endpoints, as a percentage of the total coating composition weight on a wet weight basis.

These additives may be present in the coating in an amount of about 2 wt. % or greater, about 5 wt. % or greater, about 10 wt. % or greater, about 20 wt. % or greater, about 30 wt. % or greater, about 40 wt. % or greater, about 50 wt. % or less, about 60 wt. % or less, about 70 wt. % or less, about 80 wt. % or less, or any value encompassed by these endpoints, as a percentage of the total coating composition weight on a dry (solids) weight basis.

Any of the coatings described above may be used in the coating compositions of the present disclosure with any of the coating compositions described below.

g. Solvents
i. Organic Solvents

The coating composition may be solvent-based and include one or more solvents. Exemplary solvents include water, alcohols such as C₁-C₈ alcohols including methanol, ethanol, isopropanol, and t-butanol, C₂-C₈ ketones including acetone and methyl n-amyl ketone (2-heptanone), C₂-C₂₀ ethers including dipropylene glycol methyl ether and methoxy propyl acetate (DOWANOL™ PMA).

The organic solvent may be present in the composition in an amount of about 0 wt. % or greater, about 1 wt. % or greater, about 5 wt. % or greater, about 10 wt. % or greater, about 15 wt. % or greater, about 20 wt. % or greater, about 25 wt. % or greater, about 30 wt. % or greater, about 35 wt. % or less, about 40 wt. % or less, about 45 wt. % or less, about 50 wt. % or less, about 55 wt. % or less, about 60 wt. % or less, about 65 wt. % or less, about 70 wt. % or less, or any value encompassed by these endpoints, as a percentage of the total coating composition weight on a wet weight basis.

After the coating has been applied and cured, the total coating composition may be substantially free of organic solvent. In other words, the organic solvent may be present in the composition in an amount of about 1 wt. % or less, about 0.5 wt. % or less, or about 0.1 wt. % or less of the total coating composition weight on a dry (solids) weight basis.

The coating composition, when solvent-based, may be substantially free of water. In other words, water may be present in the coating composition in an amount of about 1 wt. % or less, about 0.5 wt. % or less, about 0.1 wt. % or less, or 0 wt. %, as a percentage of the total coating composition.

ii. Aqueous Compositions

The coating may alternatively be formulated as a waterborne coating composition. When a waterborne coating composition is used, the fluoride component may be pre-formed as an aqueous mixture. The fluoride component may be present in the aqueous pre-mix in an amount of about 2 wt. % or greater, about 10 wt. % or greater, about 20 wt. % or greater, about 35 wt. % or less, about 40 wt. % or less, about 45 wt. % or less, about 50 wt. % or less, or any value or range encompassed by these endpoints, as a percentage of the total aqueous premix.

Water may be present in the aqueous premix in an amount of about 30 wt. % or greater, about 40 wt. % or greater, about 50 wt. % or greater, about 65 wt. % or less, about 70 wt. % or less, about 75 wt. % or less, about 80 wt. % or less, or any range or value encompassed by these endpoints, as a percentage of the total aqueous premix.

The aqueous premix may further include a co-solvent. Suitable co-solvents may include ethylene glycol monobutyl ether (EGBE), for example. The co-solvent may be present in the aqueous premix in an amount of about 0 wt. %, about 1 wt. % or greater, about 2 wt. % or greater, about 3 wt. % or greater, about 4 wt. % or greater or greater, about 5 wt. % or less, about 6 wt. % or less, about 7 wt. % or less, about 8 wt. % or less, about 9 wt. % or less, about 10 wt. % or less, or any range of value encompassed by these endpoints, as a percentage of the total aqueous premix.

The aqueous premix may further include other additives, such as dispersants, surfactants, and defoamers, for example.

To form the waterborne coating composition, the aqueous premix may be combined with an aqueous resin dispersion. The resin may comprise a phenoxy resin a silicone polyester resin, and/or a silicone polyurethane resin.

The resin may be present in the aqueous resin dispersion in an amount of about 15 wt. % or greater, about 20 wt. % or greater, about 25 wt. % or greater, about 30 wt. % or less, about 35 wt. % or less, about 40 wt. % or less, or any value or range encompassed by these endpoints, as a percentage of the total aqueous resin dispersion.

The aqueous resin dispersion may comprise water in an amount of about 10 wt. % or greater, about 15 wt. % or greater, 20 wt. % or greater, about 25 wt. % or less, about 30 wt. % or less, about 35 wt. % or less, about 40 wt. % or less, or any value or range encompassed by these endpoints, as a percentage of the total aqueous resin dispersion.

The aqueous resin dispersion may further comprise one or more co-solvents. Suitable co-solvents may include butanol, DOWANOL™ PM, DOWANOL™ PMA, and/or propylene glycol (PG).

The aqueous resin dispersion may further comprise a silicone emulsion. The silicone emulsion may be present in the aqueous resin dispersion in an amount of about 30 wt. % or greater, about 35 wt. % or greater, about 40 wt. % or greater, about 4 wt. 5% or greater, about 50 wt. % or less, about 55 wt. % or less, about 60 wt. % or less, about 65 wt. % or less, or any value or range encompassed by these endpoints, as a percentage of the total aqueous resin dispersion.

The waterborne coating composition may comprise the aqueous premix in an amount of about 10 wt. % or greater, about 15 wt. % or greater, about 20 wt. % or less, about 25 wt. % or less, about 30 wt. % or less, or any value or range encompassed by these endpoints, as a percentage of the total coating composition.

The waterborne coating composition may comprise the aqueous resin dispersion in an amount of about 70 wt. % or greater, about 75 wt. % or greater, about 80 wt. % or less, about 85 wt. % or less, or any value or range encompassed by these endpoints, as a percentage of the total coating composition.

The waterborne coating composition may comprise an organic oil including silicone oil in an amount of about 1 wt. % or greater, about 2 wt. % or greater, about 3 wt. % or greater, about 4 wt. % or greater, about 5 wt. % or less, about 6 wt. % or less, about 7 wt. % or less, about 8 wt. % or less, about 9 wt. % or less, about 10 wt. % or less, or any value or range encompassed by these endpoints, as a percentage of the total coating composition.

### V. Methods of Forming Coatings

a. Mixing of Components

The coating composition may be formulated by mixing its separate components. Once the components have been mixed, the composition may be applied to the substrate.

In one aspect, the components may be mixed together prior to applying the resulting coating composition to a substrate. In other aspects, subsets of the components may be prepared with each subset including components that are not reactive with other components within each subset, with two or more subsets of the components being combined prior to applying the resulting composition to the substrate.

b. Flashing

After the coating composition is applied to the substrate, the resulting coating may be flash heated. The coating may be flash heated at a temperature of about 80° C. or higher, about 100° C. or higher, about 120° C. or higher, about 140° C. or higher, about 150° C. of lower, about 170° C. or lower, about 190° C. or lower, about 200° C. or lower, or any value encompassed by these endpoints.

The coating may be flash heated for a period of time of about 1 minute or more, about 2 minutes or more, about 5 minutes or more, about 8 minutes or more, about 10 minutes or less, about 12 minutes or less, about 15 minutes or less, about 18 minutes or less, about 20 minutes or less, or any value encompassed by these endpoints.

Following flash heating of the coating, the coating may be cured as described below.

c. Curing

Curing may occur very slowly at room temperature, but curing is typically accomplished in at elevated temperatures, such as in a box or tunnel oven.

Following application of the coating, the coating may be cured at a temperature of about 200° C. or higher, about 225° C. or higher, 250° C. or higher, about 275° C. or higher, about 300° C. or lower, about 325° C. or lower, about 350° C. or lower, about 400° C. or lower, or any value encompassed by these endpoints.

The coating may be cured for about 5 minutes or longer, about 10 minutes or longer, about 15 minutes or longer, about 20 minutes or longer, about 25 minutes or longer, about 30 minutes or less, about 45 minutes or less, about 60 minutes or less, or any value encompassed by these endpoints.

### VI. Coating Properties

As discussed below, the coating may be characterized by hardness, resistance to deformation, abrasion and scratch resistance, impact resistance, chemical resistance, and resistance to thermal degradation, for example. Each of these characteristics is described in further detail below.

a. General Coating Properties

The coating may include the siloxane matrix, the organic polymer and an inorganic reinforcing filler, illustratively a hard inorganic reinforcing filler such as silicone carbide. Without wishing to be bound by theory, it is possible that the inclusion of a hard inorganic reinforcing fillers increases the abrasion resistance by deflecting forces applied to the topcoat.

The coatings of the present disclosure may be free of fluoropolymers. In other words, the coatings of the present disclosure include fluoropolymers in an amount of 1 wt. % or less, 0.5 wt. % or less, or 0.1 wt. % or less, based on the total weight of the coating on a wet weight basis. The coatings of the present disclosure include fluoropolymers in an amount of 1 wt. % or less, 0.5 wt. % or less, or 0.1 wt. % or less, based on the total weight of the coating on a dry (solids) weight basis.

The coatings of the present disclosure provide high hydrophobicity and good non-stick properties. Hydrophobicity may be determined using contact angle measurements. For example, a contact angle goniometer may be used with deionized water. The static and dynamic water contact angles may be measured using a Kruss Drop Shape Analyzer DSA100 Instrument. sWCA was measured by depositing a 2.0 μL drop on the surface of the panel and calculated using ADVANCE software from the Krass DSA100 instrument. Advancing and receding water contact angles were measured by moving the needle into the middle of the drop and “making” or “aspirating” a drop. Delay time between each action (i.e., make a drop, measure, or aspirate) was 8 s to enable complete equilibration of the drop before measurement.

A satisfactory static water contact angle (sWCA) may be defined as an sWCA of not less than 90 degrees, which is in turn defined as a hydrophobic surface. In general, for the purpose of better release and easy cleaning performance, a higher water contact angle is better, for example, higher than 100 degrees, higher than 105 degrees, higher than 110 degrees, higher than 115 degrees, or higher than 120 degrees.

Additional satisfactory nonstick properties may include sufficient cohesion, lack of surface cracking, thermal inertial in the cooking temperature environment, and lack of reactivity with food (as demonstrated in burnt milk and fried egg tests).

b. Abrasion and Scratch Resistance

The coatings may be tested to determine their abrasion and scratch resistance, as well as their chemical resistance and resistance to thermal degradation. These characteristics may be used to describe the performance of the coating.

Abrasion resistance may be determined by British Standard 7069-1988, EN 12983-1:2004, and Taber abrasion tests, for example. As used herein, abrasion resistance is determined using a Dry Reciprocating Abrasion Test (DRAT). This test measures the resistance of coatings to abrasion by a reciprocating Scotch-Brite pad. Scotch-Brite pads are made by 3M Company, Abrasive Compositions Division, St Paul, MN 55144-1000. Pads come in grades with varying levels of abrasiveness as follows: Lowest—7445, 7448, 6448, 7447, 6444, 7446, 7440, 5440—Highest. A Scotch-Brite 7447 pad was used and changed every 1000 cycles.

The inclusion of hard reinforcing fillers in the composition increases the scratch resistance of the coating compositions. Specifically, as shown in the Examples below, reinforcing fillers with Knoop hardness of 160 kg/m2 or greater increase both the abrasion and scratch resistance of the coating. It appears that harder reinforcing fillers provide more improvements in resistance than softer particles.

### EXAMPLES

The following non-limiting Examples illustrate various features and characteristics of the present disclosure, which is not to be construed as limited thereto. Throughout the Examples and elsewhere herein, percentages are by weight unless otherwise indicated.

### Example 1: Mixtures of Calcium Fluoride (CaF₂) and Silicone Polyester

A mixture of CaF₂ particles in a silicone polyester resin was pre-formed to make the final formulation. The silicone polyester resin is commercially available, e.g., SILIKOFTAL® HTL 2 silicone polyester resin from Evonik, and SILIKOFTAL® HTT silicone polyester resin from Evonik. The amount of CaF₂ in the mixture is calculated as its solid percentage by weight with respect to the solids of silicone polyester resin.

The CaF₂ solid percentage is chosen as 0 wt. %, 10 wt. %, 20 wt. %, 30 wt. %, 40 wt. %, and 50 wt. % for Runs 1 to 6.

TABLE 2

| Component | Run 1 | Run 2 | Run 3 | Run 4 | Run 5 | Run 6 |
|---|---|---|---|---|---|---|
| CaF₂ solid (wt. %) | 0 | 10 | 20 | 30 | 40 | 50 |
| Silicone polyester | 70.69 | 67.86 | 65.17 | 62.72 | 60.45 | 49.64 |
| resin | | | | | | |
| Methyl n-amyl ketone | 23.41 | 22.48 | 21.58 | 20.77 | 20.02 | 16.44 |
| CaF₂ particles | 0 | 4.00 | 7.81 | 11.28 | 14.51 | 29.78 |
| DOWANOL ™ PMA | 5.90 | 5.66 | 5.44 | 5.23 | 5.02 | 4.14 |
| Total | 100 | 100 | 100 | 100 | 100 | 100 |

### Example 2: Coating Compositions

Coating formations in Example 2 using runs 1-6 of Example 1 were made with 82.35 g of the pre-mixed formulations from runs 1 to 6, and with additional amounts of other components as shown in the table below.

TABLE 3

| Component | Run 7 | | Run 8 | | Run 9 | | Run 10 | | Run 11 | | Run 12 | |
|---|---|---|---|---|---|---|---|---|---|---|---|---|
| Run 1 | 82.35 | g | | | | | | | | | | |
| Run 2 | | | 82.35 | g | | | | | | | | |
| Run 3 | | | | | 82.35 | g | | | | | | |
| Run 4 | | | | | | | 82.35 | g | | | | |
| Run 5 | | | | | | | | | 82.35 | g | | |
| Run 6 | | | | | | | | | | | 82.35 | g |
| Silicone polyester resin | 0.77 | g | 0.77 | g | 0.77 | g | 0.77 | g | 0.77 | g | 0.77 | g |
| DOWANOL ™ PMA | 1.99 | g | 1.99 | g | 1.99 | g | 1.99 | g | 1.99 | g | 1.99 | g |
| Black pigment | 0.2 | g | 0.2 | g | 0.2 | g | 0.2 | g | 0.2 | g | 0.2 | g |
| Slip/flow agent | 0.35 | g | 0.35 | g | 0.35 | g | 0.35 | g | 0.35 | g | 0.35 | g |
| Xylene | 11.37 | g | 11.37 | g | 11.37 | g | 11.37 | g | 11.37 | g | 11.37 | g |
| Silicone oil | 2.68 | g | 2.68 | g | 2.68 | g | 2.68 | g | 2.68 | g | 2.68 | g |
| Al flake pigment | 0.29 | g | 0.29 | g | 0.29 | g | 0.29 | g | 0.29 | g | 0.29 | g |
| Total | 100 | g | 100 | g | 100 | g | 100 | g | 100 | g | 100 | g |

The coating compositions were coated on an aluminum substrate and then cured at 274° C. for 5 min. The percentage of calcium fluoride (CaF₂) in the topcoat dry film was calculated from the coating composition. The percentages are shown below in Table 4.

TABLE 4

| | Run 7 | Run 8 | Run 9 | Run 10 | Run 11 | Run 12 |
|---|---|---|---|---|---|---|
| CaF₂ wt. % | 0 | 8.07 | 15.09 | 20.99 | 26.09 | 46.24 |
| in dry film | | | | | | |

### Example 3: Comparative Examples

Several comparative examples were formulated to compare the effect of CaF₂ in the coating compositions. Descriptions of these examples are provided in Table 5 below.

TABLE 5

| | Comparative | Comparative | Comparative | Comparative |
|---|---|---|---|---|
| | formulation | Formulation | Formulation | Formulation |
| | A | B | C | D |
| Descrip- | Commercial | Commercial | Commercial | Silicone |
| tion | low-end PTFE | high-end PTFE | non-PTFE | polyester |
| | cookware | cookware | bakeware | coating, |
| | | | | alumina to |
| | | | | replace CaF₂ |

### Example 4: Contact Angle Measurements and Release Data

Initial static water contact angle, advancing water contact angle, and receding water contact angle were measured using a Kruss Drop Shape Analyzer DSA100 Instrument. sWCA was measured by depositing a 2.0 μL drop on the surface of the panel, and calculated using ADVANCE software from the Kruss DSA100 instrument. Advancing and receding water contact angles were measured by moving the needle into the middle of the drop and “making” or “aspirating” a drop. Delay time between each action (i.e., make a drop, measure, or aspirate) was 8 s to enable complete equilibration of the drop before measurement.

To further test the coatings, a dry egg release test was conducted. The pan was heated to 121 to 148° C. and the eggs were cooked without oil or fat. After cooking, a rating of 1 to 5 was given based on how the egg was released. The average rating was calculated from 5 individual ratings.

Finally, a burnt milk test was conducted. The pan was heated to 392° F. (200° C.), and 30 mL of half-and-half milk was placed into the pan and cooked until brown. The ease with which the residue is removed is graded on a scale of 1 to 5, with 5 being the best. The average rating over 5 cycles is provided in Table 6, along with the other results discussed above.

TABLE 6

| | Initial | | | | Burnt milk |
|---|---|---|---|---|---|
| | static | Advancing | Receding | Dry egg | cold water |
| | water | water | water | release | clean- |
| | contact | contact | contact | average | ability |
| | angle (°) | angle (°) | angle (°) | rating | rating |
| Run 7 (no | 107.2 | 107.4 | 92.2 | 3.6 | 3.7 |
| CaF₂) | | | | | |
| Run 8 | 108.4 | 104.5 | 95.5 | 3.7 | 3.7 |
| Run 9 | 106.8 | 107.0 | 86.4 | 4 | 4.3 |
| Run 10 | 108.7 | 107.8 | 97.9 | 4.5 | 4.5 |
| Run 11 | 108.1 | 107.1 | 100.4 | 5 | 5 |
| Run 12 | 109.1 | 108.7 | 96.6 | 4.2 | 4.5 |
| Comparative | 124.3 | 138.1 | 99.3 | 3 | 3 |
| Formulation A | | | | | |
| Comparative | 114.6 | 133.3 | 97.6 | 5 | 5 |
| Formulation B | | | | | |
| Comparative | 103.4 | 105.2 | 85.4 | 1.6 | 1 |
| Formulation C | | | | | |
| Comparative | 90.4 | 78.3 | 31.3 | 3.6 | 3.6 |
| Formulation D | | | | | |

### Example 5: Waterborne Coating Compositions

An aqueous premix comprising CaF₂ was formulated, along with an aqueous resin composition. These components, along with silicone oil, were formulated into a waterborne coating composition.

A mixture of CaF₂ particles was pre-formed in water with a small amount of a co-solvent (ethylene glycol monobutyl ether (EGBE)), a dispersant (BYK 192), a surface defoamer (S 440, S104H), and dimethylethanolamine. The composition is shown below in Table 7.

TABLE 7

| Component | Function | Amount wt. % |
|---|---|---|
| De-ionized water | Solvent | 52.61 |
| Ethylene glycol monobutyl ether | Co-solvent | 4.98 |
| BYK 192 | Dispersant | 1.99 |
| S 440 | Surfactant/defoamer | 0.18 |
| S104H | Surfactant/defoamer | 0.18 |
| Dimethylethanolamine | Amine | 0.18 |
| CaF₂ | Fluoride component | 39.88 |
| Total | | 100 |

Next, an aqueous resin solution was formed using a Phenoxy PKH 34 resin, a silicone emulsion (D15005), water, and several co-solvent and additives as shown in Table 8 below.

TABLE 8

| Component | Function | Amount wt. % |
|---|---|---|
| Phenoxy PKH 34 | Resin | 23.46 |
| D15005 | Silicone emulsion | 47.95 |
| PG | Co-solvent | 2.03 |
| TEG | | 0.5 |
| Dow PM | Co-solvent | 2.03 |
| Cymel 327 | | 3.04 |
| Butanol | Co-solvent | 0.5 |
| Suefynol 440 | | 0.5 |
| Deionized water | Water | 19.99 |
| Total | | 100 |

Finally, three different waterborne coating compositions were formulated using the components shown above. Run 18 was performed as a control experiment in which no CaF₂ was used. The compositions of the waterborne coating compositions are shown below in Table 9.

TABLE 9

| Component | Run 18 | Run 19 | Run 20 |
|---|---|---|---|
| Pre-mix of CaF₂ in water | 0 | 15 | 14.34 |
| Waterborne resin solution | 100 | 85 | 81.26 |
| MEM 24 (silicone oil emulsion, 50% solids) | 0 | 0 | 4.4 |

### Example 6: Contact Angle Measurements and Release Data for Waterborne Coatings

The same contact angle and cleanability tests as described above were conducted for the waterborne coatings. The results are shown below in Table 10.

TABLE 10

| | Initial static | Advancing | Receding | Dry egg | Burnt milk |
|---|---|---|---|---|---|
| | water | water | water | release | cold water |
| | contact | contact | contact | average | cleanability |
| | angle (°) | angle (°) | angle (°) | rating | rating |
| Run 18 | 85.5 | 85.9 | 56.5 | 2 | 2 |
| Run 19 | 84.5 | 91.9 | 52.2 | 2 | 2 |
| Run 20 | 94.6 | 100.6 | 67.1 | 2 | 2 |

### Example 7: Calcium Fluoride and Silicone Polyester Compositions and Properties

### I. Materials and Methods

### A. Egg Release Test

The coating compositions were evaluated with standard testing, which is similar to EN 12983-1: 2000 with some modifications, and described below in details:

### 1. Cooking

Place the coated utensil on the center of hotplate. Allow to heat while monitoring the temperature with the thermocouple. Allow the utensil to heat to 150° C. 170° C. (300° F. 340° F.). Alternatively, if a thermocouple is not available, the temperature may be judged by sprinkling a few drops of water on the surface periodically as the utensil heats.

Gently break the egg into the center of the coated utensil. Cook without the addition of extra fat until it is set and just beginning to turn brown.

When it has browned, approximately after two minutes, lift the egg with the spatula. Free the egg completely from the surface, noting the amount of effort required. Once the egg has been freed, remove the utensil from the burner and tilt. Note the ease or difficulty with which the egg slides in the bottom of the utensil.

### 2. Evaluation of Egg-Release Testing

Record effort required to free the egg from surface. An egg that lifts easily from surface with no sticking around edges indicates excellent release. Diminishing release down to complete sticking may be noted by amount of effort required to lift the egg.

A numerical and descriptive rating system is as follows:

TABLE 11

| Numeric | Descriptive | Performance |
|---|---|---|
| 5 | Excellent | No sticking in center or around |
| | | edges of egg. Slides easily |
| 4 | Good | Slight sticking around edges. |
| | | Slides easily |
| 3 | Fair | Moderate sticking on edges; |
| | | slight sticking in centre. |
| | | Slides only if steeply tilted |
| | | and shaken |
| 2 | Poor | Requires considerable effort |
| | | to free egg but can be freed |
| | | intact. Does not slide. |
| 1 | Very poor | Egg cannot be freed from |
| | | surface without breaking up. |

### B. Burnt-Milk Test

The coating compositions were evaluated with standard testing, which is similar to EN 12983-1: 2000 with some modifications, and described below in details:

### 1. Cooking

Initially, turn on electric or gas burner to a medium setting (“5” on electric burner or one-half full on gas). Place utensil on burner and using the thermocouple, adjust the burner setting so that the maximum temperature that the empty utensil reaches is 410-430° F. (210-220° C.). 3.2. This burner setting may vary dramatically depending on the thickness and composition of the utensil tested. After determining and recording the burner setting, remove the utensil from the stove and allow pan to cool to below 120° F. (50° C.) before starting the test.

Begin the test by putting the cooled utensil back on the burner at the predetermined burner setting. Add the milk to the utensil. From this time, the heating portion of the test should take 5-10 minutes to complete.

The utensil should be watched closely for the duration of the test. Soon after beginning the test, a skin forms on the surface of the milk. Throughout most of the test, this skin “breathes” due to the evaporation of water from the milk.

Right before the test concludes this skin will collapse, and the rapid burning of the milk and darkening of this skin will commence. The test is stopped when no steam but only smoke has been seen coming off the utensil.

This completes the heating portion of the test. Remove the utensil from the burner.

A “pancake” of burned milk will be left in the bottom of the utensil. Evaluate the effort it takes to remove this “pancake” form the bottom of the utensil. By placing the utensil still hot under a stream of cold tap water. If any residue is left behind, determine the ease that this is removed from the coated surface by scraping with a non-abrasive soft sponge

### 2. Evaluation of Burnt-Milk Testing

Note the effort necessary to remove “pancake”, the amount of residue left on coated surface, and the difficulty removing this residue in order to assign the proper rating to the test.

A numerical and descriptive rating system is as follows:

TABLE 12

| Numeric | Descriptive | Performance |
|---|---|---|
| 5 | Excellent | No sticking in center or around edges |
| | | of“pancake”. “Pancake” removed intact. |
| 4 | Good | Slight sticking around edges of utensil with |
| | | or without a small amount of easily removed |
| | | residue. |
| 3 | Fair | “Pancake” sticks on edges and in the center. |
| 2 | Poor | “Pancake” sticks and cannot be removed |
| | | completely, leaving half of portion stuck on the |
| | | surface. |
| 1 | fail | “Pancake” more than half stuck on the surface |

### II. Composition and Properties of Calcium Fluoride and Silicone Polyester Compositions

Example 7 has the following composition: 55% Silicone Polyester SILIKOFTAL® HTL 2 silicone polyester resin from Evonik, 40% Calcium Fluoride on resin solids, 1.5% high molecular weight silicone oil, 7.5% D16027 Si Oil Premix. The high molecular weight oil is DC9770 with an approximate molecular weight of 14000 g/mol, and D16027 Si Oil premix is a blend of N-propyl acetate (81.82%), XIAMETER PMX-200 silicone fluid 100 CST (9.09%), and XIAMETER OHX-0135 silicone (9.09%). The details of the formulation are described in Table 13 and Table 14.

TABLE 13

| Component | Amount (wt. %) |
|---|---|
| Silicone polyester resin (60% solids) | 60.45 |
| Methyl n-amyl ketone | 20.02 |
| CaF₂ particles | 14.51 |
| DOWANOL ™ PMA | 5.02 |
| Total | 100 |

TABLE 14

| Component | Amount (g) |
|---|---|
| CaF₂ grind (see Table 13) | 82.35 |
| Silicone polyester resin (60% solids) | 0.77 |
| DOWANOL ™ PMA | 1.99 |
| Black pigment | 0.2 |
| Slip/flow agent | 0.35 |
| Xylene | 5.2 |
| D16027Silicone Oil Premix (18.02% of oil) | 7.5 |
| High Molecular Weight silicone oil (100%) | 1.5 |
| Al flake pigment | 0.29 |
| Total wet formulation | 100 |
| Total CaF₂ solids in the wet formulation | 11.95 |
| Total silicone polyester solids in the formulation | 30.33 |
| Total non-volatile additive (silicone oil + pigments) | 3.69 |
| in the formulation | |
| Dry total solids of the formulation | 45.97 |
| CaF₂ weight in dry film (%) | 25.99 |

TABLE 15

| Coating from Table 14 | Egg-release Test | Burnt Milk Test |
|---|---|---|
| 1 | 5 | 4.9 |

### Example 8: Calcium Fluoride and Silicone Polyester with Silicone Oil Compositions and Properties

### I. Materials and Methods

### A. Dishwasher Test

### 1. Washing Method

The dishwasher test includes introduction of coated pans in Frigidaire dishwasher under heated dry setting (2 h and 15 m) using Cascade detergent.

### 2. Evaluation of Dishwasher Test

After dishwash exposure, panels were evaluated according to the ratings described above in the section “Egg-Release Test” and “Burnt Milk-Release Test” in the Materials and Methods section of Example 7.

II. Composition and Properties of Calcium Fluoride and Silicone Polyester Compositions with Silicone Oil

The composition of Example 8 is similar to Example 7 and is summarized in Table 16 below. The key difference between the compositions of Examples 7 and Examples 8 is the silicone oil level was varied while the ratio of CaF₂ to Silicone polyester is held constant. The optimum amount of high molecular weight silicone oil (1%) in conjunction with D16027 silicone oil mix exhibited superior performance.

TABLE 16

| | | | | | | | Burnt Milk |
|---|---|---|---|---|---|---|---|
| | | | High | | Egg-Release | Burnt | Release |
| | CaF₂ | D16027 | molecular | | Test after 5 | Milk | Test after 5 |
| | wt. % in | silicone | weight Oil | Egg | Dishwash | Test | Dishwash |
| Composition | dry film | oil mix | (%) | Test | test* | **** | Test |
| 1 | 25.99 | 7.5 | 0 | 5 | 5, 4, 4, 3, 3 A = | 4.8 | failed first |
| | | | | | 3.8 | | cycle |
| 2 | 25.99 | 7.5 | 1 | 5 | 5, 5, 5, 5, 5, Av = 5 | 4.9 | 4, 5, 4.5, 5, 4.5 |
| | | | | | | | Av = 4.6 |
| 3 | 25.99 | 7.5 | 1.5 | 5 | 4.5, 5, 4, 5, 4.5 | 4.9 | 2, 2, 2, 2, 2 |
| | | | | | Av = 4.6 | | Av = 2 |
| 4 | 0 | 7.5 | 1 | 3 | fail | fail | fail |

### Example 9: Composition and Properties of Coatings without Silicone Oil

Example 9 relates to the coating compositions comprising aluminum oxide or different metal fluoride fillers, and do not comprise silicone oil. The physical properties of these coatings were evaluated via thermal conductivity, glass transition temperature and solvent swelling.

Table 17 illustrates the coating compositions used for free-film formation employing the cathodic disbondment process. The formulation procedure was carried out substantially as described in Example 7, except no silicone oil was incorporated in the formulation other metal fluorides were processed and incorporated as CaF₂. For the physical properties study, since there was a need of free-film of each coating compositions, native-CaF₂ was replaced by oleic acid modified CaF₂ for coating fabrication (See the section below “surface functionalization of CaF₂”). The sole purpose to functionalize the CaF₂ surface was to obtain a workable free film. In the attempts of coating fabrication comprising native CaF₂, the free films produced were very fragile and did not maintain the film integrity after cathodic disbondment. However, we confirmed that oleic acid surface CaF₂ and native-CaF₂ have similar non-stick food release properties in final coatings. The details of formulations used for free-film formation of coatings by cathodic delamination are provided in Table 17 below.

TABLE 17

| | Material | Composition | | | | | | | |
|---|---|---|---|---|---|---|---|---|---|
| Materials | composition | 1 | 2 | 3 | 4 | 5 | 6 | 7 | 8 |
| 7122 silicone polyester | Polymer binder | 70.33 | 64.85 | 60.17 | 60.17 | 60.17 | 60.17 | NIL | NIL |
| (60%) | | | | | | | | | |
| Methyl N-Amyl Ketone | solvent | 23.63 | 21.83 | 20.24 | 20.24 | 20.24 | 20.24 | NIL | NIL |
| (MnAK) | | | | | | | | | |
| Propylene glycol methyl | solvent | 5.79 | 5.34 | 4.95 | 4.95 | 4.95 | 4.95 | NIL | NIL |
| ether acetate (PMA) | | | | | | | | | |
| Twin 4100 | Wetting/anti-crater | 0.2 | 0.2 | 0.2 | 0.2 | 0.2 | 0.2 | NIL | NIL |
| | additive | | | | | | | | |
| Oleic acid* modified | Inorganic Filler | NIL | 7.78 | 14.44 | NIL | NIL | NIL | NIL | NIL |
| CaF₂ | | | | | | | | | |
| MgF₂ | Inorganic Filler | NIL | | NIL | 14.44 | NIL | NIL | NIL | NIL |
| SrF₂ | Inorganic Filler | NIL | NIL | | NIL | 14.44 | NIL | NIL | NIL |
| Al₂O₃ | Inorganic Filler | NIL | NIL | NIL | NIL | NIL | 14.44 | NIL | NIL |
| D9199CZ PTFE | Fluoro-carbon | NIL | NIL | NIL | NIL | NIL | NIL | 100 | 96 |
| PFA | flurocarbon | NIL | NIL | NIL | NIL | NIL | NIL | | |
| SIC F360 | filler | NIL | NIL | NIL | NIL | NIL | NIL | NIL | 4 |
| Total | | 100 | 100 | 100 | 100 | 100 | 100 | 100 | 100 |
| Total silicone polyester | | 42.198 | 38.91 | 36.1 | 36.1 | 36.1 | 36.1 | | |
| dry solids | | | | | | | | | |
| CaF₂ wt. % in dry film | | | 20 | 40 | | | | | |
| MgF₂ wt. % in dry film | | | | | 40 | | | | |
| SrF₂ wt. % in dry film | | | | | | 40 | | | |
| Al₂O₃ wt. % in dry film | | | | | | | 40 | | |

Oleic acid surface modification of CaF₂ was solely performed to obtain free-films of coating by cathodic disbondment process and evaluate using different analytical characterization methods. It is important to mention that oleic acid does not contribute to the release property, and also did not require in case of other inorganic filler particles. The CaF₂ was functionalized with oleic acid via dropwise addition of neat oleic acid to CaF₂ powder. The ratio of CaF₂ and oleic acid was varied from (0.1 (CaF2):0.01 (oleic acid) to 0.1 (CaF2:0.003 (Oleic acid)). After the complete addition of oleic acid, the mixture was rolled for 2 h and subsequently heat treated at 80° C. until dry powder is obtained. To ensure the functionalization, powder was characterized via static water contact angle measurements

For the free-film formation, coatings were fabricated on tin-plated steel substrate, immersed in 0.1 N Na₂SO₄ solution, and a voltage of 15 v was applied. In this process, the coated panel acted as a cathode, whereas platinum was used an anode. The voltage application enables disbondment of coating from the substrate and produce a free film. The thickness of free films was in the range of 20-50 microns, which were further used for physical properties evaluation such as thermal conductivity, glass transition temperature and solvent swelling resistance. A similar characterization was performed for coating compositions comprising alumina and other metal fluoride fillers. In case of these fillers, native-filler produced workable free-film and there was no need for surface functionalization with oleic acid.

Thermal conductivity of films was measured using software-controlled thermal interface materials (TIM) equipment (ASTM D5470). Briefly, the free-film specimens were clamped between a pair of parallel conductive copper disks of 3 cm, a specific amount (0.3 mL; sigma Aldrich grade, 100 CST) of silicone oil was spread on films for homogenous contact, and then heat-flow through the free-film were measured.

FIG. 1 illustrates the thermal conductivities for various free films obtained from all coating compositions. It can be clearly seen that the coating composition comprised of CaF₂ is standing out among the other fillers. Apparently, other metal fluorides (BaF₂ and MgF₂) also exhibited higher thermal conductivity, however statistically they showed large standard deviation and their limit overlapped with thermal conductivity with Al₂O₃ and SrF₂.

Another set up thermal conductivity experiment was conducted to see the effect of CaF2 loading in the coating matrix. FIG. 2 describes that loading of CaF₂ in coating composition is directly proportional to the thermal conductivity. The higher the loading, the higher is the thermal conductivity.

Note: This property was measured using coatings comprised of CaF₂ surface modified with oleic acid. Although, oleic acid does not contribute to the release property, but it was solely used to obtain free-films by cathodic disbondment process.

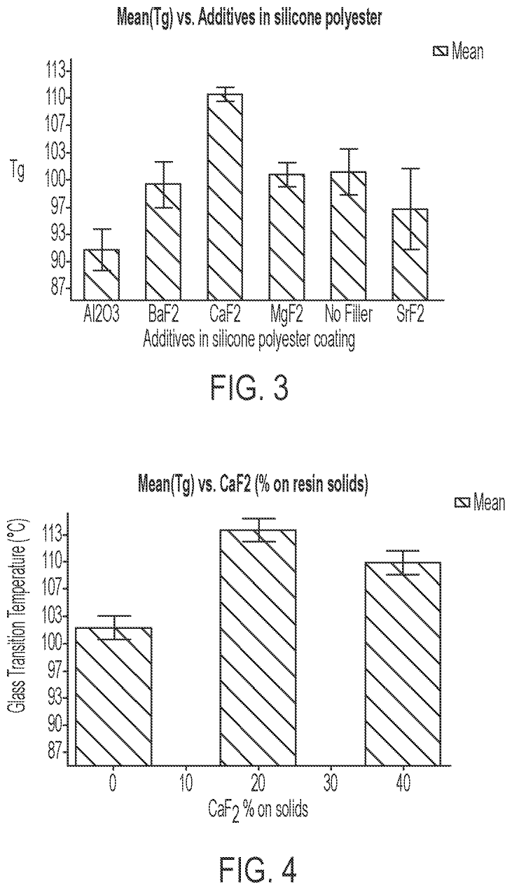

To study the effect of fillers on degree of curing/cross-linking of coating compositions, glass transition temperature (Tg) was measured using differential scanning calorimetry (DSC). FIG. 3 shows that the Tg of silicone polyester significantly increased when CaF₂ is added into the coating. This suggests that incorporation of CaF₂ could have led to increased cross-linked molecular structure or higher degree of cure of silicone polyester coating. On the other hand, Al₂O₃ decreased the Tg of final coating which indicates softening of silicone polyester coating in presence of Al₂O₃. However, coatings comprised of BaF₂, MgF2 and SrF₂ did not show statistically significant change in Tg of the final coating.

In summary, the Tg of coating followed the order below: CaF₂>No Filler≈MgF₂≈BaF₂≈SrF₂>Al₂O₃.

The data in FIG. 4 shows that when loading of CaF₂ is varied from 20% to 40% (on solids), a maximum increase in the Tg (around 10 units) was observed for 20% loading which then slightly dropped at 40% loading.

Surprisingly, no distinct Tg was observed for PTFE-based coatings.

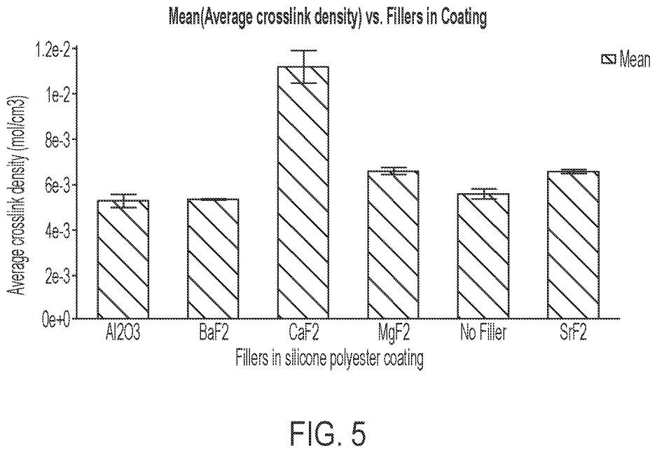

The swelling or softening of a film/coating when it is exposed to a solvent can indicate the relative cross-link density of coatings. The coatings comprised of different fillers were exposed to methylene chloride solvent to study the swelling and cross-link density of cure silicone polyester coatings. FIG. 5 shows that in comparison to other fillers, CaF₂ significantly improves the cross-link density of coating.

The non-stick properties of coatings were evaluated by testing the release of cooked egg and burnt milk which is described in the Materials and Methods section of Example 7. The results are summarized in Table 18. In addition to the dry-release properties, coatings were also evaluated by the oily appearance, pre-heating time and thermal transport. The rating of these testing parameters was performed based on the visual inspection, where higher number suggests better performance property.

The food-release performance in different coating compositions followed the following trend: CaF₂>>BaF₂>MgF₂>CaCO₃>No Filler

TABLE 18

| | | | | | Pre- | | |
|---|---|---|---|---|---|---|---|
| Filler in | Oily | | | | heating | | |
| Silicone | surface | Cooked | | | time and | | |
| polyester | of | egg | Burnt milk | Clean- | thermal | Final | |
| coating | coating | release | release | up | transport | Surface | Total |
| No Filler | 2 | 3, 3, 3, 2, 2 | 3, 2, 2, 2, 2 | 2 | 2 | 2 | 12.8 |
| | | Average | Average 2.2 | | | | |
| | | 2.6 | | | | | |
| CaF₂ | 5 | 4, 5, 5, 5, 5 | 5, 5, 5, 5, 5 | 5 | 5 | 5 | 29.8 |
| | | Average | Average 5 | | | | |
| | | 4.8 | | | | | |
| BaF₂ | 1 | 5, 5, 3, 3, 4 | 5, 5, 4, 4, 3 | 3 | 4 | 4 | 20.2 |
| | | Average | Average 4.2 | | | | |
| | | 4.0 | | | | | |
| MgF₂ | 2 | 4, 3, 3, 3, 3 | 3, 3, 3, 3, 2 | 3 | 3 | 3 | 17.0 |
| | | Average | Average 2.8 | | | | |
| | | 3.2 | | | | | |
| CaCO₃ | 2 | 3, 2, 2, 2, 2 | 4, 3, 3, 3, 3 | 3 | 2 | 3 | 15.4 |
| | | Average | Average 3.2 | | | | |
| | | 2.2 | | | | | |

The oily surface of coatings was evaluated with visual ratings which are defined in Table 19 below.

TABLE 19

| Numeric | Descriptive | Performance |
|---|---|---|
| 5 | Excellent | Negligible to very low amount of silicone oil |
| | | on the surface of coating. No streaks visible |
| | | with finger rubbing |
| 4 | Good | Increased amount of silicone oil on the surface |
| | | of coating. |
| 3 | Fair | Oily appearance showing streaks/may not be |
| | | acceptable for some customers |
| 2 | Poor | Very oil appearance, not acceptable |
| 1 | fail | Thin film of silicone can be observed and badly |
| | | streaks. Not acceptable |

The clean-up ability of coatings was evaluated with visual ratings which are defined in Table 20 below

TABLE 20

| Numeric | Descriptive | Performance |
|---|---|---|
| 5 | Excellent | No cleaning is necessary |
| 4 | Good | Slight residue which can be cleaned solely |
| | | with rinsing cold water |
| 3 | Fair | Slight residue which can be clean with a |
| | | combination of cold water and paper towel |
| 2 | Poor | High residue which can be cleaned with a |
| | | mixture of detergent and cold water |
| 1 | fail | High residue and needs warm/hot water and |
| | | scrubbing to clean |

The preheating and thermal transport of the coatings were evaluated by measuring the time taken by each coatings to reach at required cooking temperature which are defined in Table 21 below.

TABLE 21

| Numeric | Descriptive | Performance |
|---|---|---|
| 5 | Excellent | Temperature of coating surface reaches to |
| | | cooking temperature within pre-heating time |
| | | parameter (2 min) |
| 4 | Good | Temperature of coating surface reaches to |
| | | cooking temperature within 2.5 min |
| 3 | Fair | Temperature of coating surface reaches to |
| | | cooking temperature within 2.75 min |
| 2 | Poor | Temperature of coating surface reaches to |
| | | cooking temperature within >3 min |
| 1 | fail | Coating temperature reaches to required |
| | | temperature slowly, outside of the test- |
| | | procedure |

The final surface of the coatings was evaluated with visual ratings which are defined in Table 22 below.

TABLE 22

| Numeric | Descriptive | Performance |
|---|---|---|
| 5 | Excellent | No left-over cooking residue. No damage to |
| | | coating. |
| 4 | Good | Slight residue that can be cleaned with paper |
| | | towel only with minimum scratch. |
| 3 | Fair | Slight residue that can be cleaned with paper |
| | | towel only with relatively more scratch. |
| 2 | Poor | Heavy residue that can be cleaned with a |
| | | combination of detergent, water, and sponge. |
| | | Relatively high scratch. |
| 1 | fail | Heavy residue, difficult to clean, high amount |
| | | of scratching, and other defects including |
| | | color change. |

### Example 10: Coating Composition with Silicone Resin and No CaF₂ Particles

This example relates to the coating compositions comprising pure silicone resin with and without CaF₂ particles. The formulation components are summarized in Table 23 and Table 24. The formulation steps involved dissolution of silicone resin in 1-Methoxy-2-propylacetate (PMA/MPA) for 40-50 mi under stirring conditions. CaF₂ was incorporated by grinding it with glass media to obtain better dispersion and average particle size of 13 microns.

TABLE 23

| Component | Amount (g) |
|---|---|
| 1-Methoxy-2-propylacetate (PMA/MPA) | 34 |
| XIAMETER RSN-0233 flake silicone resin* | 66.00 |
| Total | 100 |

TABLE 24

| | Comparative | |
|---|---|---|
| | Sample 2 | |
| Component | Amount (g) | Sample 1 |
| Xiameter silicone solution (Table 8) | 28.26 | 28.26 |
| DOWSIL RSN-0808 Resin** | 34 | 34 |
| 1-methoxy-2-propylacetate (PMA/MPA) | 12.68 | 12.68 |
| xylene | 22.42 | 8.08 |
| D16027 Silicone oil additive | 2.52 | 2.52 |
| CaF2 | NIL | 14.4 |
| Total | 100 | 100 |

In Tables 23 and 24, the XIAMETER RSN-0233 flake silicone resin is a silanol-functional 100% silicone resin with Phenyl/Methyl Ratio of 1.3 and degree of substitution of 1.15. The DOWSIL RSN-0808 Resin is a silanol-functional silicone resin in xylene having Phenyl/Methyl Ratio of 0.6/1.0 and degree of Substitution of 1.5

TABLE 25

| Sample (refer | | Initial egg | Initial burnt | Egg test | Burnt milk test |
|---|---|---|---|---|---|
| Table 24) | Coating | release | milk release | after 5 DW | after 5 DW |
| 1 | Si + 40% | 5, 4.5, 3, 3, 3 | 2, 2, 2, 2, 0, | 2, 2, 2, 1, 0 | 1, 0 |
| | CaF₂ | Av = 3.7 | Av = 1.6 | | |
| 2 | Si only | 3, 2, 5, 3, 3 | 1.5, 1.5, 0, | 1, 1, 2, 1, 0 | 0 |
| | | Av = 3.2 | Av = 0.6 | | |

In Table 25 above, the egg release and burnt milk testing were performed on separate pans.

Based on this ladder study, it appears that the calcium fluoride component begins to take effect at a level of 20% based on total resin solids and performs well at 40%. Amounts of greater than 40% lead to reduced gloss and thermal property changes. Amounts of less than 20%, including 0, lead to a sticky surface, which may be due to low the Tg of the silicone polyester resin.

Wherein particular examples of this invention have been described above for purposes of illustration, it will be evident to those skilled in the art that numerous variations of the details of the present invention may be made without departing from the invention as defined in the appended claims. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A siloxane-based coating composition in liquid form, comprising:
a siloxane resin;
a fluoride component selected from calcium fluoride (CaF₂), magnesium fluoride (MgF₂), strontium fluoride (SrF₂), barium fluoride (BaF₂), and combinations of the foregoing, present in an amount from 5 wt. % to 50 wt. %, based on a total weight of the coating composition; and
a solvent.

2. The siloxane-based coating composition of claim 1, wherein the fluoride component is present in an amount from 10 wt. % to 50 wt. %, based on the total weight of the coating composition.

3. The siloxane-based coating composition of claim 1, further comprising an organic oil present in an amount from 0.01 wt. % to 10.0 wt. %, based on a total weight of the coating composition.

4. The siloxane-based coating composition of claim 1, wherein the organic oil is a number average molecular weight silicone oil of 12,000 g/mol or greater.

5. The siloxane-based coating composition of claim 1, wherein the fluoride component comprises calcium fluoride (CaF₂).

6. The siloxane-based coating composition of claim 1, further comprising aa reinforcing filler is present in an amount from 1 wt. % to 10 wt. %, based on the total weight of the coating composition.

7. The siloxane-based coating composition of claim 1, wherein the solvent comprises water, and the coating composition includes non-aqueous solvents in an amount less than 5 wt. %, based on the total weight of the coating composition.

8. The siloxane-based coating composition of claim 1, comprising a total amount of fluoropolymers of 0.1 wt. % or less, based on the total weight of the coating composition.

9. A coated article, comprising:
a substrate having a surface; and
a coating disposed on the surface, comprising:
a siloxane resin; and
a fluoride component selected from calcium fluoride (CaF₂), magnesium fluoride (MgF₂), strontium fluoride (SrF₂), barium fluoride (BaF₂), and combinations of the foregoing, present in an amount from 10 wt. % to 60 wt. %, based on the total weight of the coating.

10. The coated article of claim 9, wherein the fluoride component is present in an amount from 20 wt. % to 50 wt. %, based on the total weight of the coating.

11. The coated article of claim 9, wherein the coating further comprises an organic oil is present in an amount of 0.01 wt. % to 10.0 wt. % based on a total weight of the coating.

12. The coated article of claim 9, wherein the organic oil is a number molecular weight silicone oil of 12,000 g/mol or greater.

13. The coated article of claim 9, wherein the fluoride component comprises calcium fluoride (CaF₂).

14. The coated article of claim 9, further comprising a reinforcing filler is present in an amount from 1 wt. % to 10 wt. %, based on the total weight of the coating.

15. The coated article of claim 9, wherein the coating has a static water contact angle of no less than 90°.

16. The coated article of claim 9, comprising a total amount of fluoropolymers of 0.1 wt. % or less, based on the total weight of the coating.
